(19) United States
(12) Patent Application Publication
(10) Pub. No.: US 2022/0067931 A1
(43) Pub. Date: Mar. 3, 2022

(54) METHOD FOR PREDICTING THE RISK OF RECURRENCE AFTER RADIATION TREATMENT OF A TUMOR

(71) Applicants: UNIVERSITE DE BORDEAUX, BORDEAUX (FR); INSTITUT POLYTECHNIQUE DE BORDEAUX, TALENCE Cedex (FR); CENTRE NATIONAL DE LA RECHERCHE SCIENTIFIQUE, PARIS (FR); CENTRE HOSPITALIER UNIVERSITAIRE DE BORDEAUX, TALENCE Cedex (FR)

(72) Inventors: Baudouin DENIS DE SENNEVILLE, TALENCE (FR); Arnaud HOCQUELET, LAUSANNE (CH); Hervé TRILLAUD, BORDEAUX (FR)

(21) Appl. No.: 17/415,702

(22) PCT Filed: Dec. 19, 2019
(86) PCT No.: PCT/EP2019/086168

§ 371 Date: Jun. 17, 2021

(30) Foreign Application Priority Data
Dec. 27, 2018 (FR) 1874251

(51) Int. Cl. G06T 7/00

(52) U.S. Cl. CPC G06T 7/0012; G06T 2207/30096; G06T 2207/10088

(57) ABSTRACT

A method for predicting the risk of recurrence after a treatment of a tumor with radiation, includes the following steps: a first step of obtaining at least a first 3D image of the tumorous region, apt to allow the tumor to be viewed; a second step of obtaining at least a second 3D image of the tumorous region, apt to allow a treated region to be viewed; a step of processing the obtained first and second 3D images so as to determine an exposure distance for all or some of first voxels inside the tumor; a step of comparing the determined exposure distances with a predefined distance threshold, so as to determine whether at least one exposure distance is smaller than or equal to said predefined threshold. A system for predicting the risk of recurrence is also provided.

### TECHNICAL FIELD OF THE INVENTION

The present invention relates to a method and system for making medical predictions in the field of treatment of a tumor with radiation.

The present invention more precisely relates to a method and system for predicting a risk of recurrence after a treatment of a tumor with radiation.

The method according to the invention may be applied in a preoperative planning phase, in particular to determine an optimal intervention strategy: in this case, it is used with simulated post-treatment data.

The method according to the invention may also be applied in a postoperative planning phase: in this case, it is used with real post-treatment data.

The method according to the invention may generally be used as a method for assisting with decision making.

### PRIOR ART

Techniques for treating a tumor with radiation are medical techniques that consist in applying radiation to the tumor, so as to obtain cell destruction, without resection. Radiation is to be understood in a broad sense, insofar as it may be a question of electromagnetic radiation, particle beams, thermal radiation or even of the application of an electric field.

Techniques for treating a tumor with radiation may comprise electroporation, thermotherapy or radiotherapy and especially hadron therapies such as carbon therapy or proton therapy.

For example, thermotherapy consists in making temperature (hyperthermia or hypothermia) vary in the tumor, so as to obtain cell destruction. It may be a question of treatment with radiofrequencies, microwaves, focused ultrasound, or a laser (hyperthermia) or of cryotherapy (hypothermia). The intervention consists in implanting probes, or fine needles, within the tumor using imaging, which probes will heat or freeze the tumor in order to destroy it.

Among these techniques, the technique of radiofrequency (“RF”) ablation is a very promising approach to the treatment of tumors. Radiofrequency ablation is a thermotherapy technique used for the treatment of localized tumors, and in particular for the treatment of liver, lung, kidney and bone tumors. Radiofrequency ablation is particularly suitable for a tumor size generally smaller than 5 cm, and it is often necessary to resort to a procedure employing multiple and overlapped ablations.

In practice, at least one radiofrequency probe is introduced via the cutaneous route into the target tumor. Next, a high-frequency alternating current (frequency typically between 450 and 600 kHz) is delivered via the probe through the tumor, so as to cause agitation of ionic molecules of the tissues, this having the effect of generating heat via friction. This heat-generating effect depends on the electrically conductive properties of the tissues.

Prior to the treatment with radiation, a phase called the “preoperative planning phase” on the one hand aims to assess the extent of the tumor by virtue of suitable imaging techniques, for example computed tomography (also “CT” below) or magnetic resonance imaging (also “MRI” below), suitable for determining the size, number, location and shape of the tumor, or tumors if there are a plurality of tumor foci (or nodules). On the other hand, the preoperative planning phase aims to prepare the treatment.

Thus, the information obtained on the tumor allows the treatment region to be targeted; a suitable radiation technique and hardware, a suitable probe in particular, to be chosen; the implantation of said hardware to be defined; and, depending on the size of the tumor, how many times said probe will need to be inserted to be defined.

During the treatment phase, the radiation ablation is guided by one or more suitable imaging techniques (echography, CT, MRI, etc.), especially in order to check whether a probe is inserted in the correct position and with the planned inclination, and if necessary to correct the position and/or inclination of a probe, or even to check whether the radiation is being correctly applied to the targeted region.

In thermotherapy techniques, the temperature of the probe, and more particularly of the probe tip making contact with the target, may be controlled. In particular, in hyperthermia techniques, the temperature that it is sought to obtain in the tumor is generally located between 60 and 100° C. and it must generally be maintained for a time that may for example vary between 5 and 10 minutes. From 60° C. and beyond a time that depends on the selected hyperthermia technique, the tumorous tissues may be irreversibly necrosed via protein denaturation. However, above 100° C. and a time longer than a few seconds, the tissues carbonize, this reducing electrical and thermal conduction as a result of the insulating effect thereof.

After the treatment, there follows a phase of assessing the results of the ablation, one or more suitable imaging techniques (CT, MRI, etc.) also being used in this phase.

With a view to achieving effective radiation ablation, an ablation region is defined that comprises the target tumor and a minimum safety margin to be observed around said target tumor. In other words, a minimum safety margin to be observed between the limit of the tumor and the limit of the ablation region is defined.

Specifically, the ablation region must be a size such as to ensure destruction of the entire tumor while preserving healthy tissues in the vicinity of the tumor. It is therefore also possible to speak of an “optimum safety margin”.

The optimum safety margin may be set to a few millimeters, for example between 5 and 10 millimeters for hepatocellular carcinoma (also referred to as “HCC”) and metastases.

Generally, the value of the optimum safety margin varies depending on the tumor treated and on the aggressiveness grade of the tumor. The aggressiveness grade of a tumor may be determined on the basis of size-related criteria and of analyses of texture using images obtained by MRI for example. Usually, the aggressiveness grade of a tumor is also quantified using a biopsy.

One issue with radiation ablation is how, on the one hand, to define an optimal safety margin that must be observed between the limit of the tumor and the limit of the ablation region, and, on the other hand, to determine the margin of safety that was observed during treatment (which could also be called the “treatment margin”).

Regarding the latter point, methods for determining the safety margin observed during treatment do exist. For example, patent US2014/0064446 describes a method and device for determining a treatment margin of a target region, comprising the following steps:
acquiring an image pre- and post-treatment of the target region,
segmenting the images in order to determine the outlines thereof,
quantifying the treatment margin of the target region.

In this way, the practitioner is able to assess whether the treatment margin is correct or whether it is necessary to continue the ablation treatment.

It is possible, if such an assessment is carried out immediately after the treatment, to continue the treatment if the treatment margin is judged insufficient, while the patient is still under anesthesia.

Radiation ablation is much less invasive than conventional surgical resection. However, this technique currently has limitations.

Even if the step of assessing the results of the ablation indicates that the tumor tissues have been completely necrosed, there remains a rate of local recurrence, this recurrence being accompanied by a progression of the tumor in the months or years (typically two years) that follow the treatment, ranging from 10 to 30%.

Excluding tumor biology, the recurrence rate seems to be a result of an insufficiently accurate definition of the optimal safety margin and above all of an insufficiently accurate assessment of the actual safety margin, which does not take into account the complex shape of the tumor.

In order to improve the technique of radiation ablation, it has been identified that an accurate estimation of the treated tumorous area having a treatment margin less than or equal to a given optimum safety margin (which may be set to a few millimeters, between 5 and 10 millimeters for example) should allow patients at high risk of recurrence after a treatment with radiation to be better identified. In other words, a correlation has been found between the risk of recurrence in a group of patients treated with radiation and the value of the under-treated tumorous area, i.e. of the area treated with an insufficient safety margin.

A method has therefore been sought for determining the tumorous area treated with a treatment margin less than or equal to the given optimum safety margin, so as to predict a risk of recurrence, and to be able to intervene accordingly.

The issue is illustrated in FIGS. 1a and 1b, which schematically illustrate two different ablation regions (in white) around the same tumor (in gray). These two cases have identical minimum margins, but different tumor exposure areas. Specifically, in both cases the minimum margin is equal to zero millimeters but in case 1a the exposed area of the tumor is small whereas in case 1b the exposed area of the tumor is larger. The probability of non-treatment of satellite nodules, and therefore of recurrence, is higher in case 1b.

For example, a predicting method exists that is based on an image-processing technique, comprising acquiring at least a first image taken before the treatment and containing the area of the tumor to be ablated and acquiring at least one second image taken after the treatment and containing the treated area (or ablation area); bringing the first and the second images into registration; and segmenting the ablation area and the area of the tumor on the basis of the first and second images so as to determine areas treated with margins less than or equal to the given optimum safety margin, with respect to the areal limits of the tumor. This method and the results of the clinical study are published in the article “Three-dimensional Measurement of HCC ablation zones and margins for predicting local tumor progression” A. Hocquelet et al.

However, the recurrence rate remains significant. Thus, the inventors provide a predicting method and system intended to decrease the recurrence rate and/or spread of the tumor following a treatment with radiation.

One objective of the invention is to predict more accurately and more surely a risk of recurrence and/or of spread of a tumor following a treatment with radiation.

Another objective of the invention is to provide a predicting method and system that are simple to use, while improving prediction accuracy.

### SUMMARY OF THE INVENTION

One subject of the invention allowing this aim to be achieved is a method for predicting the risk of recurrence after a treatment of a tumor with radiation, comprising the following steps:
a first step of obtaining at least a first 3D image of the tumorous region, apt to allow the tumor to be viewed;
a second step of obtaining at least a second 3D image of the tumorous region, apt to allow a treated region to be viewed;
a step of processing the obtained first and second 3D images so as to determine an exposure distance for all or some of first voxels inside the tumor.

The method according to the invention further preferably comprises:
a step of comparing the determined exposure distances with a predefined distance threshold, so as to determine whether at least one exposure distance is smaller than or equal to said predefined threshold.

According to the invention, by “tumorous region” what must be understood is the region comprising the tumor visible on imaging and the vicinity around said tumor. The extent of the vicinity around the tumor is variable and is typically defined by the practitioner. It may be a safety interval comprising at least the optimum safety margin and/or a region around the tumor the microscopic tumorous invasion of which is not visible on imaging.

According to the invention, by “3D image” what is meant is a synthetic image represented in a system of three coordinates. A 3D image may be obtained directly using suitable imaging techniques, MRI for example, or may be obtained using a series of two-dimensional images, for example obtained by CT or MRI or even by echography.

By the term “voxel”, what must broadly be understood is a volume element of a 3D image with which data (color, brightness, density, etc.) may be individually associated. A volume element or voxel may especially be defined in various ways and is not necessarily cubic and/or spherical. For example, it may be a 3D facet. The 3D image may thus be defined as a set of voxels. Furthermore, the first voxels inside the tumor comprise the voxels comprised in the tumor, containing the area of the tumor.

When two 3D images are superposed, the images may be designated 3D “masks”.

Throughout this description, the “treated region” corresponds to the portion of the tumorous region that has been ablated or necrosed and may also be designated the “ablation region”. The “untreated region” corresponds to the portion of the tumorous region that has not been ablated or necrosed.

According to the invention, by “exposure distance” of a tumor voxel, what must be understood is the distance between said tumor voxel and the closest outer edge of the treated region, or in other words the minimum distance between said tumor voxel and the untreated region.

Throughout this description, the “distance threshold” or “exposure-distance threshold” is equivalent to the term “optimum safety margin” such as defined above.

The method according to the invention is a predicting method that is simple to use while being accurate insofar as it takes into account the volume of the tumor and the volume of the (treated or untreated) region around the tumor. It may easily be automated and/or computerized.

Furthermore, it allows the optimum safety margin to be adjusted, especially when used preoperatively. More broadly, it allows a treatment to be simulated and the intervention strategy to be optimized. It is also a decision-making tool for a practitioner, who may decide to react quickly after the treatment.

According to one embodiment, the method further comprises an intermediate step of spatially matching the first and second 3D images, said intermediate step being after the first and second obtaining steps and before or during the step of processing the obtained first and second 3D images.

According to the invention, by “spatially matching” or “matching” images, what must be understood is any operation that consists in matching at least two images in order to be able to compare or combine their respective information. Such an operation may also be designated “registration”.

According to one particular embodiment, the intermediate matching step comprises a first sub-step of scaling the first and second 3D images, so that said first and second 3D images are at the same voxel scale in all three dimensions, this for example consisting in implementing an interpolation method.

According to one particular embodiment, the intermediate matching step comprises a second sub-step of superposing the first and second 3D images, this for example consisting in implementing an image-registration method.

According to one embodiment, the processing step comprises a first segmenting step in which the at least one first 3D image is segmented, so as to identify the tumor.

According to one embodiment, the processing step comprises a second segmenting step in which the at least one second 3D image is segmented, so as to identify the treated region.

According to the invention, by “segmenting” or “segmentation” what must be understood is any image-processing operation the aim of which is to group together pixels or voxels meeting defined criteria. The pixels or voxels are thus grouped into regions, which amount to a tiling or a partition of the image. An example of segmentation is binarization, which produces two classes of pixels or voxels; in general they are represented by black pixels or voxels and white pixels or voxels.

According to the invention, a segmentation may be carried out on a series of 2D images or on one 3D image.

According to one embodiment, the first step of obtaining a first 3D image of the tumorous region is carried out by acquiring at least one image before the treatment of the tumor, for example by MRI, computed tomography or echography.

According to one embodiment, at least one among the first and second 3D images is obtained via a series of 2D images.

According to one embodiment, the second step of obtaining a second 3D image of the tumorous region is carried out by acquiring at least one image after the treatment of the tumor, for example by MRI, computed tomography or echography.

According to one alternative embodiment, the second step of obtaining a second 3D image of the tumorous region after treatment is carried out via simulation of a treated region.

According to one embodiment, the processing step comprises: a first sub-step of processing the first 3D image so as to determine first voxels inside the tumor.

According to one embodiment, the processing step comprises:
a second sub-step of processing the second 3D image so as to obtain second voxels of the untreated region; and
a third sub-step of determining an exposure distance for all or some of the determined first voxels, this consisting in determining the smallest of the 3D Euclidean distances between said first voxel and the second voxels of the untreated region.

According to one particular embodiment, the computation of the smallest of the Euclidean distances between a first voxel and the second voxels comprises:
a first sub-step of enumerating the second voxels;
second sub-steps of computing the Euclidean distances between the first voxel and the second voxels;
a third sub-step of determining the smallest Euclidean distance among the computed Euclidean distances.

According to one particular embodiment, the processing step further comprises an additional sub-step of defining a box bounding the untreated region, so as to reduce the number of second voxels, said additional sub-step being before or during the third sub-step.

According to the invention, by “box bounding” and “bounding box”, what must be understood is a three-dimensional limiting region beyond which points, pixels or voxels, in the case of the invention, are not taken into account or sought.

According to one particular embodiment, the exposure-distance threshold is greater than or equal to five millimeters.

The invention also relates to a system for predicting the risk of recurrence after a treatment of a tumor with radiation, comprising:
means for obtaining at least a first 3D image of the tumorous region, apt to allow the tumor to be viewed;
means for obtaining at least a second 3D image of the tumorous region, apt to allow a treated region to be viewed;
a processing unit configured to obtain exposure distances for all or some of first voxels inside the tumor, from the first and second 3D images;
a comparing unit configured to compare the obtained exposure distances with a predefined distance threshold, so as to determine whether at least one exposure distance is smaller than or equal to said predefined threshold.

The processing unit may be configured to implement all or some of the embodiments of the processing step.

The means for obtaining at least a first 3D image of the tumorous region, apt to allow the tumor to be viewed, may be an MRI, a CT scanner, an ultrasound machine, or any other suitable imaging means, or even a combination of means. They may comprise means for obtaining a first 3D image from a first series of 2D images acquired before treatment.

The means for obtaining at least a second 3D image of the tumorous region, apt to allow the tumor to be viewed, may be an MRI, a CT scanner, an ultrasound machine, or any other suitable imaging means, or even a combination of means. They may comprise means for obtaining a second 3D image from a second series of 2D images after a treatment. Alternatively, they may comprise means for simulating a treated region in light of an intervention strategy, and of the first 3D image of the tumor before treatment.

Depending on whether an MRI, a CT scanner or an ultrasound machine is used, the acquired signal and consequently the acquired image may be of very different nature. In all cases, the image may be processed in order to obtain a 3D matrix containing the data of the acquired image (or images).

The method and system according to the invention may be used as a decision-making tool in the treatment of a tumor by electroporation, by thermotherapy, or by radiotherapy and especially a hadron therapy such as carbon therapy or proton therapy.

### BRIEF DESCRIPTION OF THE FIGURES

Other features and advantages of the invention will become apparent from the following non-limiting description, which is given by way of illustration, especially with reference to the appended figures, in which:

FIG. 1 FIGS. 1a and 1b schematically illustrate two different ablation regions (in white) around the same tumor (in gray);

FIG. 2 FIGS. 2a and 2b illustrate an example of images processed by the method according to the invention.

### DESCRIPTION OF EMBODIMENTS

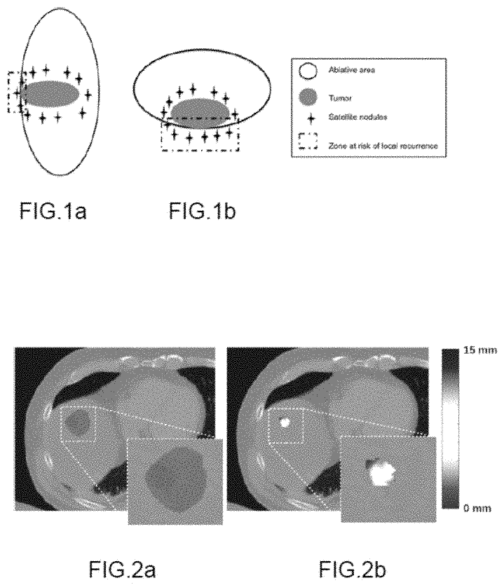

FIGS. 1a and 1a have been described in the “Prior art” section of the present description and will not be described again here.

The method according to the invention proposes to determine, in the volume of the tumorous region in question, regions that have not been treated and/or regions that have been insufficiently treated, i.e. that lie below a defined optimum safety margin, for which regions there is a risk of recurrence.

To do this, the method according to the invention consists in computing the exposure distance of all or some of first voxels located in the tumor on the basis of at least two binary 3D images (or masks):
at least a first 3D image containing the tumor;
at least a second 3D image containing the (real or simulated) treated region.

The first 3D image is acquired before the treatment.

The second 3D image may be either a 3D image acquired after an actual treatment, or a 3D image acquired via a treatment simulation.

Each 3D image (or each 2D image of a series of 2D images) is segmented using an image-processing method capable of grouping together voxels meeting defined criteria, so as to obtain first voxels inside the tumor and second voxels of the untreated region.

The first and second images are matched (or “registered”), before or after the segmenting step. Preferably, the matching comprises scaling the first and second images. The scaling may be carried out via a trilinear interpolation on a grid of voxels of common size, 1×1×1 mm³ for example. Preferably, the matching further comprises superposing the first and second images.

FIG. 2a shows an example of a coronal section of a 3D image generated by computed tomography of the liver of a patient, in which are superposed the semi-transparent binary masks of the tumor (darker central region) and of the treated region (lighter central region).

On the basis of these two binary masks, the objective is to compute a 3D map containing, for all or some of the voxels located inside the tumor, the (3D) Euclidean distance or exposure distance required to reach the exterior edge closest to the treated region.

FIG. 2b shows the 3D map of the exposure distances obtained using the masks shown in FIG. 2a.

An example of an algorithm that is fast and easy to implement digitally consists in operating directly on the voxels in the following way:
individually enumerating each first voxel (tumor voxel); and
for each tumor voxel:
   enumerating second voxels (i.e. the voxels located outside the treated region) exhaustively;
   computing the 3D Euclidean distances between the first voxel and the enumerated second voxels;
   determining the smallest of the computed 3D Euclidean distances.

Alternatively, the second voxels (i.e. the voxels located outside the treated region) may not be enumerated. For example, areas outside the tumor and the ablation region (or treated region) may be reconstructed using polygons and/or 3D facets.

A 3D map apt to provide the exposure distances for all or some of the tumor voxels is obtained.

Advantageously, a bounding box (represented by dotted lines in FIG. 2a) positioned around the treated region may be used in order to reduce the cost in terms of computing time of the enumerating steps. The bounding box may be obtained by implementing a known technique for restricting computations to a sub-region of an image.

The use of a bounding box allows the search space to be limited. In other words, instead of scrutinizing all the voxels of all of the untreated region featuring in an image and of seeking the smallest of the exposure distances between the first voxels (tumor voxels) and all the second voxels (untreated voxels), only the second voxels located in said box are scrutinized. This allows the cost in terms of computing time of the method according to the invention to be reduced.

The map of 3D exposure distances thus obtained especially makes it possible to determine whether any region (or regions) remain untreated, i.e. have a distance smaller than zero.

The map of 3D exposure distances thus obtained also makes it possible to determine whether any region (or regions) have been insufficiently treated, i.e. have a distance smaller than or equal to a defined distance threshold (or optimum safety margin). For example, the distance threshold is greater than or equal to five millimeters.

The value of the distance threshold or optimum safety margin may be defined depending on the risk of recurrence known to be run when the exposure distance is smaller than said threshold.

Further, the value of the distance threshold may vary depending on the tumor treated and on the aggressiveness grade of the tumor. The aggressiveness grade of a tumor may be determined on the basis of analyses of texture using images obtained for example by computed tomography or by magnetic resonance imaging, or other means known to those skilled in the art.

It may be seen in FIG. 2b that the region at the top left of the tumor has a 3D exposure distance smaller than the distance threshold, and may therefore be considered to have been insufficiently treated.

It is then possible to continue analyzing the images, or to take additional images or measurements, so as to characterize an insufficiently treated region by determining, for example, its volume, its center of gravity, its main axes, or even by determining whether a plurality of regions are concerned, etc.

The method according to the invention may for example be implemented by carrying out automated image processing of images obtained before treatment of the tumor and automated image processing of images obtained immediately after a first treatment of the tumor, so as to provide information apt to help a practitioner make his decision (he may decide, for example, to supplement the first treatment with a second treatment, if a risky 3D exposure distance, i.e. one smaller than the defined distance threshold, is detected; the practitioner may decide to carry out a second treatment immediately after the first treatment in order to avoid a risk of recurrence, and he may also decide to take advantage of the same therapeutic session while the patient is still under general anesthesia).

The method according to the invention is therefore a decision-making tool that may thus allow the risk of recurrence to be reduced, the decision being made by the practitioner depending on the information that he receives.

The method according to the invention may for example be implemented in one or both of the following phases: preoperative planning phase or postoperative planning phase.

Preoperative Planning Phase

As explained above, the “preoperative planning phase” is a preoperative phase that on the one hand aims to assess the extent of the tumor by virtue of suitable imaging techniques, for example computed tomography or MRI, suitable for determining or estimating characteristics of the tumor: size, number, location, volume or a plurality of volumes.

On the other hand, the determined or estimated characteristics of the tumor allow the treatment to be prepared: the treatment region to be targeted; a suitable radiation technique to be chosen; hardware, at least a suitable probe in particular, to be defined; the implantation of said hardware to be defined; the position of each probe and its inclination to be defined; and, depending on the size of the tumor, how many times the probe or probes will need to be inserted to be defined. More broadly, they allow an optimal intervention strategy to be determined.

The method according to the invention may be employed as a tool for determining the optimal intervention strategy, and especially as a tool for determining the region to be targeted, for example by reintegrating regions computed by the method to be insufficiently treated or even untreated.

In this case, the prediction method may comprise:
a first step of obtaining at least a first 3D image of the tumorous region, apt to allow the tumor to be viewed, this step being carried out by acquiring at least a first image before the treatment of the tumor;
a complementary step of defining an intervention strategy, which at least comprises defining the targeted region, which for example corresponds to a sphere or an ellipsoid containing the tumor with a specified safety margin, with a view to estimating at least one ablation volume;
a second step of obtaining a second 3D image of the tumorous region, which image is obtained by simulation depending on the defined intervention strategy so as to identify one or more simulated treated regions (and by deduction one or more simulated untreated regions).

A first 3D image may be acquired using either a CT or MRI imaging technique, and for example using a specific MRI acquisition sequence, or even using echography.

In particular, a treated region may be simulated on the basis of the intervention strategy. It is especially possible to simulate the necrosis of a tumor on the basis of the first 3D image of the tumor before treatment. In this case, the intervention strategy comprises the definition of a dose, i.e. of the applied radiation and of the duration of application, the application of which to the targeted region defined and identified in the first 3D image is simulated. The dose is applied relatively uniformly to the entire region. Via comparison with a lethal dose, it is possible to determine necrosed and therefore treated regions and non-necrosed and therefore untreated regions, and a second 3D image is thus obtained.

In this case, the prediction method may further comprise:
preferably, an intermediate step of spatially matching the first and second 3D images, which may especially comprise a step of scaling and a step of superposing the images, said intermediate step being after the first and second obtaining steps;
a step of processing the first and second 3D images so as to obtain an exposure distance for all or some of first voxels inside the tumor; and
a step of comparing the exposure distances with a predefined distance threshold, so as to determine whether at least one exposure distance is smaller than or equal to said predefined threshold.

The processing step may be carried out any time after the first and second obtaining steps and before the comparing step.

The processing step may comprise the following sub-steps:
a first sub-step of processing the first 3D image so as to determine first voxels inside the tumor;
a second sub-step of processing the second 3D image so as to obtain second voxels outside the treated region, this for example consisting of semi-automatic segmentation;
a third sub-step of determining an exposure distance for each determined first voxel, this consisting in determining the smallest of the 3D Euclidean distances between said first voxel and said obtained second voxels.

This allows a 3D map apt to provide the exposure distances for the determined first voxels to be obtained.

The 3D map thus provides, for each determined first voxel of the tumor, the distance (preferably in millimeters) from said voxel in question to the closest outer edge of the ablation region.

In particular, the 3D map allows tumor voxels that have been sufficiently treated (exposure distances larger than the defined distance threshold), insufficiently treated (exposure distances smaller than or equal to the defined distance threshold and larger than zero) or even not treated (exposure distances smaller than zero) to be determined. Thus, this especially makes it possible to determine whether there is a risk of recurrence.

This information may be used to adjust the intervention strategy (targeted region, thermal dose, etc.) so that as many tumor voxels as possible, or even all the voxels, get closer to or even exceed the exposure-distance threshold.

Thus, all the preceding steps are preferably repeated, the complementary step of defining an intervention strategy being modified each time until a 3D map is achieved that shows the tumor voxels exceeding the distance threshold. This amounts to estimating the value of the volume treated with treatment margins less than or equal to the optimum safety margin (set for example to a few millimeters).

This ultimately allows the best intervention strategy as regards avoiding the risk of recurrence, or at least minimizing it, to be determined, advantageously without it being necessary at this stage to intervene on the patient. Therefore, this makes it possible to avoid the patient having to undergo a plurality of treatments, whether they be consecutive or separated in time.

The centers of gravity of the insufficiently treated regions may advantageously be used as region to be targeted, in order to get closer to the exposure-distance threshold.

Postoperative Planning Phase.

After a treatment, a phase of evaluating the treatment may be carried out, typically by acquiring images of the tumorous region post-treatment.

The method according to the invention may be used as a decision-making tool, for example if a risky 3D exposure distance, i.e. one smaller than the defined distance threshold, is detected. The practitioner may in particular decide to supplement the first treatment with a second treatment immediately after the first treatment, in order to avoid an obvious risk of recurrence.

In this case, the prediction method may comprise:
a first step of obtaining at least a first 3D image of the tumorous region, apt to allow the tumor to be viewed, this step being carried out by acquiring at least a first image before the treatment of the tumor;
a second step of obtaining at least a second 3D image of the tumorous region, apt to allow a treated region (and an untreated region) to be viewed, this step being carried out by acquiring at least one image after a first treatment of the tumor.

A first 3D image may be acquired using either a CT or MRI imaging technique, and for example using a specific MRI acquisition sequence, or using echography.

A second 3D image may be acquired using either a CT or MRI imaging technique, and for example using a specific MRI acquisition sequence, or using echography.

Alternatively or in addition, a second image may be acquired using a thermometry imaging technique (by MRI). This may make it possible to obtain information in real time and to continuously compute a thermal-dose map, showing tissue necrosis and therefore the treated regions.

In this case, the prediction method may further comprise:
preferably, an intermediate step of spatially matching the first and second 3D images, which may especially comprise a step of scaling and a step of superposing the images, said intermediate step being after the first and second obtaining steps;
a step of processing the first and second 3D images so as to obtain an exposure distance for all or some of first voxels inside the tumor; and
a step of comparing the exposure distances with a predefined distance threshold, so as to determine whether at least one exposure distance is smaller than or equal to said predefined threshold.

The processing step may be carried out any time after the first and second obtaining steps and before the comparing step.

The processing step may comprise the following sub-steps:
a first sub-step of processing the first 3D image so as to determine first voxels inside the tumor;
a second sub-step of processing the second 3D image so as to obtain second voxels outside the treated region, this for example consisting of semi-automatic segmentation;
a third sub-step of determining an exposure distance for each determined first voxel, this consisting in determining the smallest of the 3D Euclidean distances between said first voxel and the obtained second voxels.

This allows a 3D map apt to provide the exposure distances for the determined first voxels to be obtained. This especially makes it possible to determine whether there is a risk of recurrence.

The predicting method may further comprise, if the practitioner so chooses:
a subsequent preoperative step of planning a second treatment in order to treat the regions identified as insufficiently treated.

In this subsequent step, the practitioner may decide to take advantage of the same therapeutic session while the patient is still under general anesthesia.

The method according to the invention may also be implemented in the intraoperative phase, as a decision-making tool for the operating practitioner. In this case, the steps of the method may be equivalent to those implemented in the postoperative planning phase, except that the subsequent step of planning a second treatment is replaced by a step of prolonging the current treatment in order to treat regions identified as insufficiently treated, for example by moving the treatment beam (the thermotherapy probe for example).

The invention is not limited to the embodiments described above by way of non-limiting example. It encompasses all of the variant embodiments that may be contemplated by a person skilled in the art. It will especially be understood that logical modifications may be made. Furthermore, the embodiments presented in the detailed description of the invention must not be interpreted as limiting the order of the steps and sub-steps.

Those skilled in the art will understand that the method for predicting the risk of recurrence may be implemented in various ways by hardware, software, or a combination of hardware and software elements.

The method according to the invention may be used as a tool with a view to treatment of a tumor by radiotherapy and especially a hadron therapy such as carbon therapy or proton therapy, by electroporation or by thermotherapy.

1. A method for predicting the risk of recurrence after a treatment of a tumor with radiation, comprising the following steps:
a first step of obtaining at least a first 3D image of the tumorous region, apt to allow the tumor to be viewed;
a second step of obtaining at least a second 3D image of the tumorous region, apt to allow a treated region to be viewed;
a step of processing the obtained first and second 3D images so as to determine an exposure distance for all or some of first voxels inside the tumor;
a step of comparing the determined exposure distances with a predefined distance threshold, so as to determine whether at least one exposure distance is smaller than or equal to said predefined threshold.

2. The method as claimed in claim 1, further comprising an intermediate step of spatially matching the first and second 3D images, said intermediate step being after the first and second obtaining steps and before or during the processing step.

3. The method as claimed in claim 2, the intermediate matching step comprising a first sub-step of scaling the first and second 3D images, so that said first and second 3D images are at the same voxel scale in all three dimensions, this for example consisting in implementing an interpolation method.

4. The method as claimed in claim 2, the intermediate matching step comprising a second sub-step of superposing the first and second 3D images, this for example consisting in implementing an image-registration method.

5. The method as claimed in claim 1, the processing step comprising a first segmenting step in which the at least one first 3D image is segmented, so as to identify the tumor.

6. The method as claimed in claim 1, the processing step comprising a second segmenting step in which the at least one second 3D image is segmented, so as to identify the treated region.

7. The method as claimed in claim 1, the first step of obtaining a first 3D image of the tumorous region being carried out by acquiring at least one image before the treatment of the tumor, for example by MRI, computed tomography or echography.

8. The method as claimed in claim 1, at least one among the first and second 3D images being obtained via a series of 2D images.

9. The method as claimed in claim 1, the second step of obtaining a second 3D image of the tumorous region being carried out by acquiring at least one image after the treatment of the tumor, for example by MRI, computed tomography or echography.

10. The method as claimed in claim 1, the second step of obtaining a second 3D image of the tumorous region after treatment being carried out via simulation of a treated region.

11. The method as claimed in claim 1, the processing step comprising:
a first sub-step of processing the first 3D image so as to determine first voxels inside the tumor.

12. The method as claimed in claim 1, the processing step comprising:
a second sub-step of processing the second 3D image so as to obtain second voxels of the untreated region; and
a third sub-step of determining an exposure distance for all or some of the determined first voxels inside the tumor, this consisting in determining the smallest of the 3D Euclidean distances between said first voxel and the obtained second voxels of the untreated region.

13. The method as claimed in claim 12, the computation of the smallest of the Euclidean distances between a first voxel and the second voxels comprising:
a first sub-step of enumerating the second voxels;
second sub-steps of computing the Euclidean distances between the first voxel and the second voxels;
a third sub-step of determining the smallest Euclidean distance among the computed Euclidean distances.

14. The method as claimed in claim 12, the processing step further comprising an additional sub-step of defining a box bounding the untreated region, so as to reduce the number of second voxels, said additional sub-step being before or during the third sub-step.

15. The method as claimed in claim 1, the exposure-distance threshold being greater than or equal to five millimeters.

16. A system for predicting the risk of recurrence after a treatment of a tumor with radiation, comprising:
means for obtaining at least a first 3D image of the tumorous region, apt to allow the tumor to be viewed;
means for obtaining at least a second 3D image of the tumorous region, apt to allow a treated region to be viewed;
a processing unit configured to obtain exposure distances for all or some of first voxels inside the tumor, from the first and second 3D images;
a comparing unit configured to compare the obtained exposure distances with a predefined distance threshold, so as to determine whether at least one exposure distance is smaller than or equal to said predefined threshold.
